(19) United States
(12) Patent Application Publication
(10) Pub. No.: US 2014/0180713 A1
(43) Pub. Date: Jun. 26, 2014

(54) REAL-TIME METHOD AND SYSTEM FOR MONITORING HYGIENE COMPLIANCE WITHIN A TRACKING ENVIRONMENT UTILIZING VARIOUS TIMERS

(71) Applicants: Henry J. TENARVITZ, Suttons Bay, MI (US); Robert WISER, Grawn, MI (US)

(72) Inventors: Henry J. TENARVITZ, Suttons Bay, MI (US); Robert WISER, Grawn, MI (US)

(73) Assignee: VERSUS TECHNOLOGY, INC., Traverse City, MI (US)

(21) Appl. No.: 14/170,696

(22) Filed: Feb. 3, 2014

Related U.S. Application Data
(63) Continuation-in-part of application No. 12/622,930, filed on Nov. 20, 2009.

(51) Int. Cl. G06F 19/00

(52) U.S. Cl. CPC G06F 19/327; G06F 19/325
USPC 705/2

(57) ABSTRACT

A real-time method and system are provided for monitoring hygiene compliance within a tracking environment. Auto-ID personnel tags are associated with personnel whose hygiene compliance is desired to track locations of the personnel within the environment. A first transceiver is associated with a handwashing dispenser unit. A second transceiver is associated with an entrance/exit of a patient location area. The method includes associating a first timer with the first transceiver that starts in response to activation of the dispenser. A second timer is associated with the second transceiver and starts in response to detection of personnel entering/exiting the patient location area. Hygiene-compliance is monitored based on these transceivers monitoring handwashing activity and entering/exiting the patient location area by the personnel.

### CROSS-REFERENCE TO RELATED APPLICATIONS

This application is a continuation-in-part of pending U.S. application Ser. No. 12/622,930, filed Nov. 20, 2009, the disclosure of which is incorporated in its entirety by reference herein.

### TECHNICAL FIELD

This invention relates to real-time methods and systems for monitoring hygiene compliance within a tracking environment such as a clinical environment. At least one embodiment of the invention relates to methods and systems for determining hand hygiene status and providing event notifications within a tracking environment and tags and dispenser sensors for use therein. Such methods and systems are provided to sense and locate tag-wearing persons in front of a hand hygiene cleaning agent dispenser and associate actuation of the dispenser with the sensing event, providing notifications if the subject is deemed “non-compliant” based on time delays or interaction with another subject without having completed appropriate actuation of the dispenser within a tracking environment.

### BACKGROUND

U.S. Pat. No. 5,202,666 discloses an automated device used to remind employees to wash their hands after toileting. Sensors are worn on credit card sized badges and mounted in bathroom ceilings and attached to soap dispensers and sinks When an employee enters the bathroom, the ceiling unit sensor activates a blinking light on the badge. The light is deactivated once the employee pumps the soap dispenser and stands in front of the sink for at least 15 seconds.

U.S. Pat. No. 5,945,910 discloses a hand washing and monitoring system that uses a sensor that signals the dispensation of a cleaning agent from a dispenser. A dual mode monitoring and reporting module includes an input element, an output element, a processor and memory. The module accepts data identifying an employee, receives a signal indicating dispensation of the cleaning agent and stores compliance data records.

U.S. Pat. No. 5,812,059 discloses a method and system for enhancing hygiene. An activating device is located outside a work area, a hand cleaning station is located near the work area, and a deactivating device is associated with the hand cleaning station. Upon leaving a food handling area, an indicator worn by a worker is activated when the worker is near the activating device. The indicator is deactivated only when it is determined that the worker has used the hand cleaning station.

Acquisition of infection by hospital patients is a serious healthcare problem. The Center for Disease Control, the World Health Organization and other health care organizations and agencies encourage healthcare workers to practice proper hand hygiene to reduce the transmission of pathogens via hands. Recommended procedures include the decontamination of the hands prior to direct patient contact, prior to invasive non-surgical procedures, prior to gloving, after contact with body fluid, mucous membranes, non-intact skin and wound dressings, intact skin and inanimate objects near patients. These procedures apply in hospital settings, doctor's offices, and anywhere where these personnel come into contact with patients. In some instances, application of an antimicrobial preparation to the hands is substituted for a hand washing. In any event, the goal is to reduce the microbe load on the healthcare provider's hands and prevent contamination of either the patients or healthcare providers.

Systems have been developed for monitoring the actions of workers. One such system includes badges worn by workers that are capable of transmitting or receiving information. As discussed in U.S. Pat. No. 6,236,317, workers are provided with badges that detect entry into an area that may be unsanitary and alert the workers to this fact. If a worker subsequently washes his hands or activates a disposable glove dispenser following such exposure, the alerting function of the badge is deactivated. If appropriate action is not taken by a worker, a violation is recorded by the badge or a system controller.

U.S. Pat. No. 6,882,278 describes another system that monitors compliance with recommended hand washing practices. The system includes a hand washing detector and an event detector such as a motion detector that detects an event such as a person entering or leaving a room. A control unit determines whether a person has washed his hands within a predetermined time period before entering the room.

U.S. Pat. Nos. 6,727,818 and 6,975,231 disclose other systems for promoting hygienic practices. The '818 patent discloses a system that tracks the movements of healthcare workers throughout the facility and within a patient's room. The healthcare workers are provided with badges that transmit ID information to sensors located in the hallways and rooms of the facility, which in turn transmit location information to a master station. ID information is also transmitted to wash sink sensors to indicate whether the healthcare worker has washed his hands. If the healthcare worker enters a patient contact zone in the patient's room without having complied with the required hand washing procedure, an alert is provided by the healthcare worker's badge and/or other alerting devices located on the patient's bed or in the patient's room. A time delay may be employed before a warning alert is provided so that an alert is not triggered by a healthcare worker who is only briefly in the patient contact zone.

The '231 patent discloses a system employing sets of detectors located just outside and within a patient's room. These detectors are actuated sequentially as a person enters the room and the time between their actuation is monitored in determining whether a person has entered the room. A determination is made as to whether the person has washed his hands within a predetermined period of time, and a warning signal is generated if the hands have not been washed within the set period.

As described above, it is difficult to determine the compliance rate of staff which have had interactions within infectious patients. One prior art system records these interactions so that late discovery of infections can be investigated, cross-contamination can be tracked and those who come into contact with known contamination can easily be recalled. A software package includes several reports, including a compliance report, which can be used to analyze the movement of people or items, thereby enabling one to track the spread of contagions. The compliance report demonstrates compliance with hygiene rules by displaying both successful and unsuccessful compliance. For instance, successful compliance can be represented by a staff member entering a designated “clean” zone (wash room) after entering a contaminated zone (patient room).

The following U.S. patent documents are related to the present invention: U.S. Pat. Nos. 6,392,546; 7,242,307; 7,423,533; 2008/0001763; 2008/0107636; 2008/0218351; and 2009/0091458.

The following U.S. patents are also related to the present invention: U.S. Pat. Nos. 4,868,859; 4,906,853; 5,017,794; 5,027,314; 5,027,383; 5,119,104; 5,131,019; 5,276,496; 5,355,222; 5,387,993; 5,548,637; 5,572,195; 6,104,295; 6,154,139; 6,462,656; 6,838,992; 7,286,057; 7,372,367; 7,375,640; 7,411,511; 7,443,305; 7,482,936; and 7,537,030.

Referring now to FIGS. 1 and 2, there is illustrated a prior art real-time tracking apparatus for locating subjects (i.e., persons and objects) in a tracking environment. In general, the apparatus is a combined infrared and radio frequency locating system which is adapted for use not only in medical applications, but also in non-medical applications. The apparatus is a fully automatic data collection system which provides real-time location information of personnel or equipment (i.e., subjects). Typically, information is collected using an in-ceiling and/or in-wall receiver network connected with common telephone-type wire to make accurate decisions and execute the appropriate responses. Typically, the components of the apparatus are relatively simple and modular. The apparatus and its components are specifically described in U.S. Pat. Nos. 6,154,139 and 6,838,992 which are hereby incorporated by reference in their entirety herein.

There are a number of drawbacks to current hand hygiene compliance systems, including: (1) lack of real-time location knowledge; (2) expensive specialized dispenser equipment; (3) deployment difficulty and expense to maintain; (4) specialized training requirements; and (5) an inability to leverage existing communication infrastructure.

### SUMMARY

An object of the present disclosure is to provide an improved real-time method and system for monitoring hygiene compliance in a tracking environment such as a clinical environment.

Another object of at least one embodiment of the present disclosure is to provide a method and system to determine hand hygiene status that does not require expensive specialized dispenser equipment; is simple and inexpensive to deploy and maintain; requires no special training for clinical staff; and that leverages common, pre-existing communication infrastructure, when possible.

Yet another object of at least one embodiment of the present disclosure is to provide a method and system to determine hand hygiene status in a clinical environment and provide real-time compliance or non-compliance notification as well as historical analysis of recorded hygiene procedures through use of real-time locating apparatus.

In carrying out the above object and other objects of the present disclosure, in one embodiment a real-time method of monitoring hygiene compliance within a tracking environment provided by real-time tracking apparatus is provided. Auto-ID personnel tags are associated with personnel whose hygiene compliance is desired to track locations of the personnel within the environment. Each of the personnel tags is capable of transmitting a wireless signal including ID information unique to its associated personnel tag. Personnel location information is generated based on the locations of the personnel tags within the environment. The method includes associating an auto-ID dispenser tag with each cleaning agent dispenser located within the tracking environment. Each of the dispenser tags is capable of transmitting a wireless signal including ID information. The method further includes sensing a state change which indicates activation of a particular dispenser. The method still further includes scanning a region about the activated dispenser for a first period of time in response to the state change to receive a wireless signal including its associated ID information transmitted by a personnel tag detected within the region. The method further includes utilizing the dispenser tag associated with the activated dispenser to transmit at least one wireless signal including information which identifies the detected personnel tag. The method still further includes assigning a status of hygiene compliant to the person associated with the detected personnel tag based on the signal transmitted by the dispenser tag.

The environment may be a clinical environment and the personnel may be givers of care to patients. An auto-ID patient tag is associated with each patient to track locations of patients within the environment. Patient location information based on the locations of the patient tags within the environment is generated. The method may further include recording the caregiver and patient location information and the status of the caregivers.

The method may further include assigning a status of hygiene non-compliant to the person associated with the detected personnel tag when either the detected personnel tag enters a hygiene non-compliant zone or a second period of time elapses following activation of the dispenser.

According to another embodiment, a real-time computer implemented method of monitoring hygiene compliance of personnel within a tracking environment is provided by a real-time tracking apparatus. Auto-ID personnel tags are associated with personnel in the tracking environment. Each personnel tag is capable of transmitting a wireless signal including ID information unique to its associated personnel tag. The tracking environment has a dispenser capable of dispensing a cleaning agent for hand washing. The method includes assigning a status of hygiene-compliant to a person associated with one of the personnel tags based on a first transceiver associated with the dispenser (i) sensing activation of the dispenser indicating a handwashing event, and (ii) receiving a first wireless signal that includes the ID information transmitted by the personnel tag. The method further includes starting a timer in response to the activation of the dispenser. The method further includes changing the status of hygiene-compliant to a status of hygiene-noncompliant based on (i) the timer timing out, and (ii) subsequently, a second wireless signal being received by a second transceiver associated with a passageway that communicates a patient location area with a common area, the second wireless signal including the ID information transmitted by the personnel tag indicating the personnel being in or around the passageway.

The status of the personnel may be changed from hygiene-compliant to hygiene-noncompliant based on the second transceiver associated with the passageway receiving the second wireless signal after the timer has timed out.

The dispenser and first transceiver may be located outside the patient location area. The method may further include associating a third transceiver with a second dispenser located inside the patient location area.

The method may further include starting a second timer in response to activation of the second dispenser.

The two timers may be calibratible such that they are capable of timing out after different lengths of time. Changing, setting, altering, or otherwise calibrating the timer may be accomplished via a user interface, for example.

The dispenser and the first transceiver may be located outside the patient location area. The method may further include assigning a status of hygiene-noncompliant to the person associated with the detected personnel tag based on the personnel entering the patient location area through the passageway subsequent to the timer timing out.

The dispenser and first transceiver may be located inside of the patient location area. The method may further include associating a third transceiver with a second dispenser located outside the patient location area.

The method may further include starting a second timer in response to activation of the second dispenser.

The method may further include assigning a status of hygiene-noncompliant to the person associated with the detected personnel tag based on the personnel exiting the patient location area through the passageway subsequent to the timer timing out.

According to another embodiment, a real-time computer implemented method of monitoring hygiene compliance of personnel within a tracking environment provided by a real-time tracking apparatus is provided. The auto-ID personnel tags are associated with personnel in the tracking environment. Each personnel tag is capable of transmitting a wireless signal including ID information unique to its associated personnel tag. The tracking environment has a dispenser capable of dispensing a cleaning agent for hand washing. The method includes starting a timer based on a first wireless signal being received by a first transceiver associated with a passageway that communicates a patient location area with a common area. The first wireless signal includes the ID information transmitted by the personnel tag, indicating the personnel being in or around the passageway. The method further includes assigning a status of hygiene-noncompliant based on the timer timing out without or prior to a second transceiver associated with the dispenser (i) sensing activation of the dispenser and (ii) receiving a second wireless signal that includes the ID information transmitted by the personnel tag.

The (i) sensing activation of the dispenser and the (ii) receiving a second wireless signal by the second transceiver may indicates a handwashing event by the personnel associated with the personnel tag.

The dispenser may be inside the patient location area. The step of starting may include starting the timer based on the first wireless signal being received by the first transceiver when the personnel enters the patient location area. The step of assigning may include assigning a status of hygiene-noncompliant based on the timer timing out after the personnel enters the patient location area prior to any subsequent handwashing event by the personnel.

The dispenser may be outside the patient location area. The step of starting may include starting the timer based on the first wireless signal being received by the first transceiver when the personnel exits the patient location area. The step of assigning may include assigning a status of hygiene-noncompliant based on the timer timing out after the personnel exits the patient location area prior to any subsequent handwashing event by the personnel.

The timer and any other timers may be individually calibratible such that individual personnel may program or set the timer to time out at different lengths of time.

The method may also include assigning a status of hygiene-compliant based on, prior to the timer timing out, the second transceiver sensing activation of the dispenser and receiving the second wireless signal including the ID information transmitted by the personnel tag.

The method may further include starting a second timer in response to the activation of the dispenser, wherein the second timer is calibratible such that it is enabled to differ in time from the first timer.

The second transceiver may be mounted to an existing dispenser. Alternatively, the second transceiver may be specifically incorporated into a handwashing unit to be installed in whole.

According to another embodiment, changing the status of hygiene-compliant to a status of hygiene-noncompliant may be based on either (i) at least one of the personnel entering/exiting the patient location area subsequent to the first timer timing out since the previous handwashing event, or (ii) the second timer timing out since the personnel entered/exited the patient location area without activating the dispenser.

According to another embodiment, a method may include associating a first timer with a first transceiver in a dispenser that starts in response to activation of the dispenser. The method may further include associating a second timer with a second transceiver that starts in response to detection of personnel entering/exiting a patient location area. The transceiver may be placed within or near a passageway connecting the patient location area with a common area. The method may include assigning a status of hygiene-compliant to a person associated with one of the personnel tags based on the first transceiver (i) sensing activation of the dispenser indicating a handwashing event, and (ii) receiving a first wireless signal that includes the ID information transmitted by the personnel tag. The method may include changing the status of hygiene-compliant to a status of hygiene-noncompliant based either (i) the personnel entering/exiting the patient location area subsequent to the first timer timing out since the previous handwashing event, or (ii) the second timer timing out since the personnel entered/exited the patient location area without activating the dispenser.

The methods may include performing an action based on the status of the person.

The action may include an audio or video alert.

The alert may be a video alert comprising a text or graphical alert.

The step of scanning may include the step of scanning a delimited zone in front of the dispenser to detect the personnel tag.

The hygiene may be hand hygiene and the cleaning agent may be a hand cleaning agent. The hand cleaning agent may be a hand sanitizer comprising alcohol, or a liquid or foam soap without alcohol. The timer that begins following activation of a first dispenser may be greater than or less than another timer that begins following activation of a second dispenser, which may be different than another timer that begins following detection of personnel in or near a passageway connecting the patient location area with the common area. The second dispenser may have a different hand cleaning agent associated therewith than the first dispenser such that the second period of time varies between dispensers having different hand cleaning agents associated therewith.

The state change indicating a handwashing event may be a switch state change.

The state change may indicate motion or vibration associated with activation of the dispenser.

The method may further include displaying, via a user interface, a prompt enabling a user to set individual timers associated with corresponding dispensers located in various locations, dispensers located inside of patient care rooms, dispensers located outside of patient care rooms, and dispensers having different hand cleaning agents associated therewith. Timers can also be set for sensors or transceivers on or around an entrance/exit of the patient care area such that personnel ID from the ID tags can be detected as entering/exiting a room. The prompt enables a user to set a timer that begins following activation of a dispenser located inside a patient care room, a different timer that begins following activation of a dispenser located outside the patient care room, and a different timer that begins upon the personnel entering/exiting the patient location area. A status of hygiene non-compliant may be assigned at different times after the activations of the respective dispensers or entering/exiting the patient location area. The prompt may also enable a user to set a period of time for a dispenser with a first cleaning agent associated therewith and a different period of time for a dispenser with a second cleaning agent associated therewith.

Further in carrying out the above object and other objects of the present invention, a real-time system for monitoring hygiene compliance within a tracking environment provided by a real-time tracking apparatus is provided. Auto-ID personnel tags are associated with personnel whose hygiene compliance is desired to track locations of the personnel within the environment. Each of the personnel tags is capable of transmitting a wireless signal including ID information tag. Personnel location information is generated based on the locations of the personnel tags within the environment. The system includes an auto-ID dispenser tag associated with each cleaning agent dispenser located within the tracking environment. Each of the dispenser tags being capable of transmitting a wireless signal including ID information. The system further includes a dispenser sensor configured to sense state change which indicates activation of a particular dispenser located within the tracking environment. The system still further includes a receiver associated with each of the sensors and configured to scan a region about the activated dispenser for a first period of time in response to the state change and to receive a wireless signal including its associated ID information transmitted by a personnel tag detected within the region. A dispenser tag associated with the activated dispenser transmits at least one wireless signal including information which identifies the detected personnel tag. The system still further includes apparatus configured to assign a status of hygiene complaint to the person associated with the detected personnel tag based on the signal transmitted by the dispenser tag.

The environment may be a clinical environment and the personnel may be givers of care to patients. An auto-ID patient tag is associated with each patient in the clinical environment to track locations of patients within the environment. Patient location information based on the locations of the patient tags within the environment may be generated. The caregiver and patient location information and the status of the caregiver may be recorded in a data repository.

The system may further include an apparatus for assigning a status of hygiene non-compliant to the person associated with the detected personnel tag when either the detected personnel tag enters a hygiene non-compliant zone or a second period of time elapses following activation of the dispenser.

A timer may begin when the detected personnel tag enters/exits a hygiene non-compliant zone. The hygiene non-compliant zone may include at least one of a patient room, a localized area about the patient, a patient care area, a contamination zone, a bathroom, a hallway and the like.

The system may further include an apparatus for assigning a status of hygiene non-compliant to the person associated with the detected personnel tag when the detected personnel tag enters the hygiene non-compliant zone and remains there until a third period of time elapses without a subsequent handwashing event. The third period of time may begin when the detected personnel tag enters the non-compliant zone.

The system may further include an apparatus configured to perform an action based on the status of the person.

The receiver may scan a delimited zone in front of the dispenser to detect the personnel tag.

The action may include an audio or video alert.

The alert may be a video alert comprising a text or graphical alert.

The state change may be a switch state change.

The state change may indicate motion or vibration associated with activation of the dispenser.

The hygiene may be hand hygiene and the cleaning agent may be a hand cleaning agent. The hand cleaning agent may be a hand sanitizer comprising alcohol, or a liquid or foam soap without alcohol.

Each of the dispenser tags may include a receiver so that each of the dispenser tags comprises a transceiver.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic overview diagram illustrating a prior art method and apparatus for locating subjects within a clinical environment;

FIG. 2 is a schematic block diagram specifically illustrating a prior art auto-ID tag useful with the method and apparatus of FIG. 1;

FIG. 3 is a diagram similar to the diagram of FIG. 1 but illustrating a method and system of at least one embodiment of the present invention;

FIG. 4 is a view, taken along lines A-A of FIG. 3, of an infrared receiver within a typical field of view;

FIG. 5 is a view, taken along lines B-B of FIG. 3, of an infrared receiver within a reduced field of view;

FIG. 6 is a diagram similar to the diagram of FIG. 2 but specifically illustrating an auto-ID dispenser tag useful with at least one embodiment of a method and system of the present invention;

FIG. 7 is a view of a typical report that can be generated by using at least one embodiment of the present invention;

FIG. 8 is a view of a possible text alert that can be generated and displayed using at least one embodiment of the present invention;

FIG. 9 is a view of a dashboard type graphical indicator that can be generated and displayed using at least one embodiment of the present invention;

FIG. 10 is a view of a user interface displaying a prompt enabling a user to set and control various timers associated with various dispensers using at least one embodiment of the present invention; and

FIGS. 11(a)-(d) are views of various handwashing activity accomplished by the caregiver and subject to the various timers amongst respective handwashing dispensers.

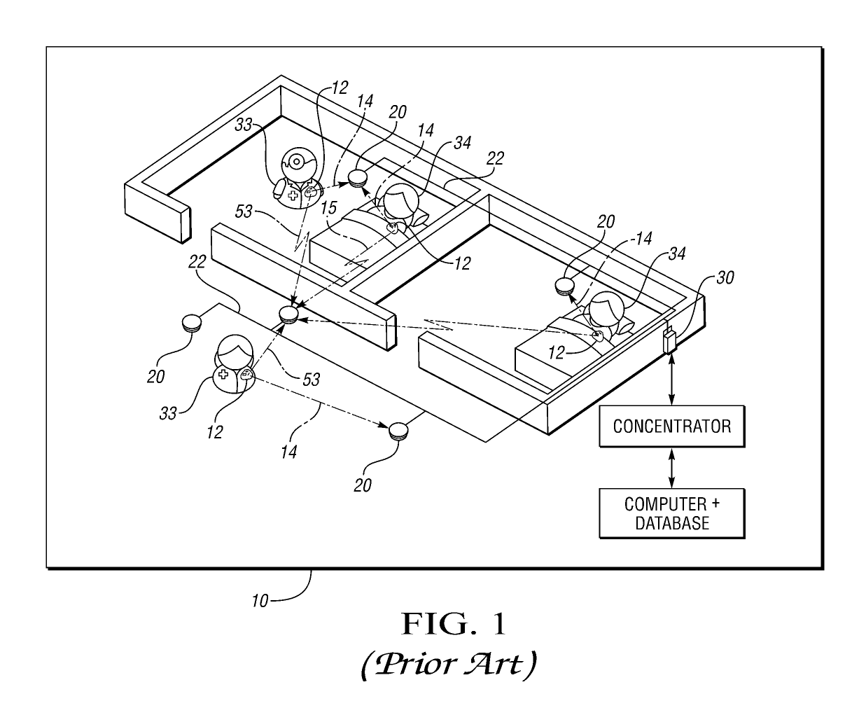

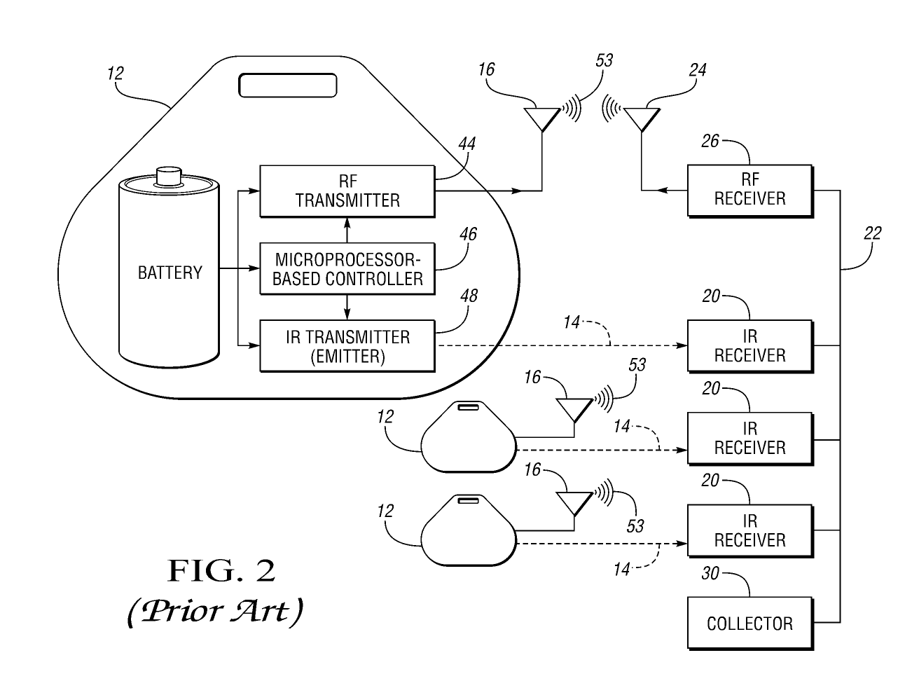

### DETAILED DESCRIPTION

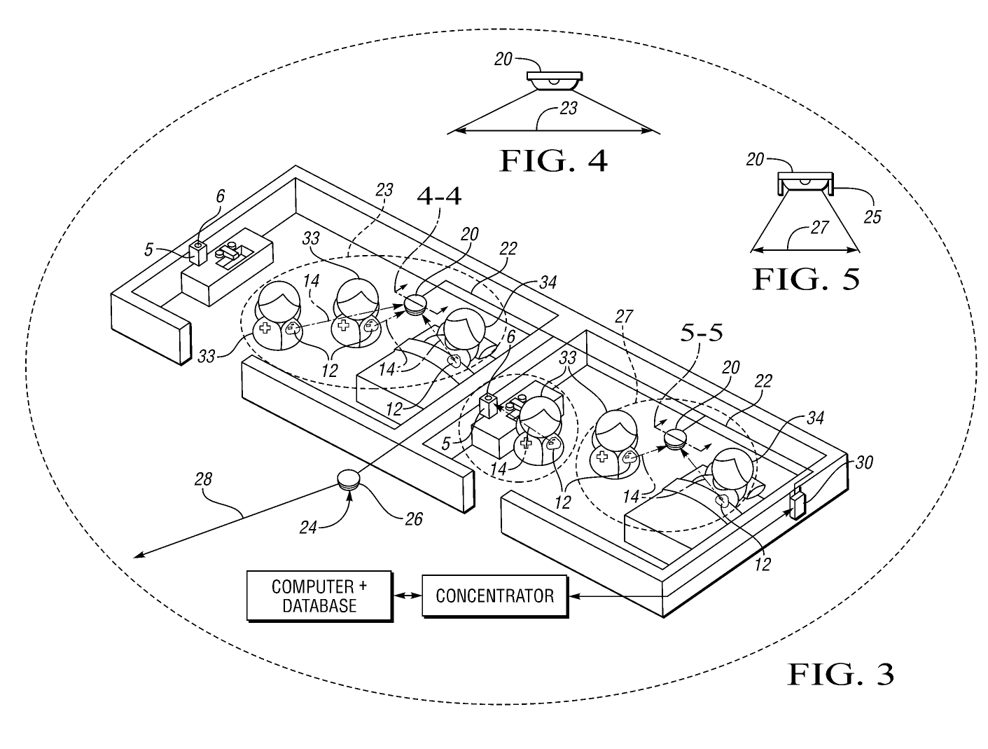

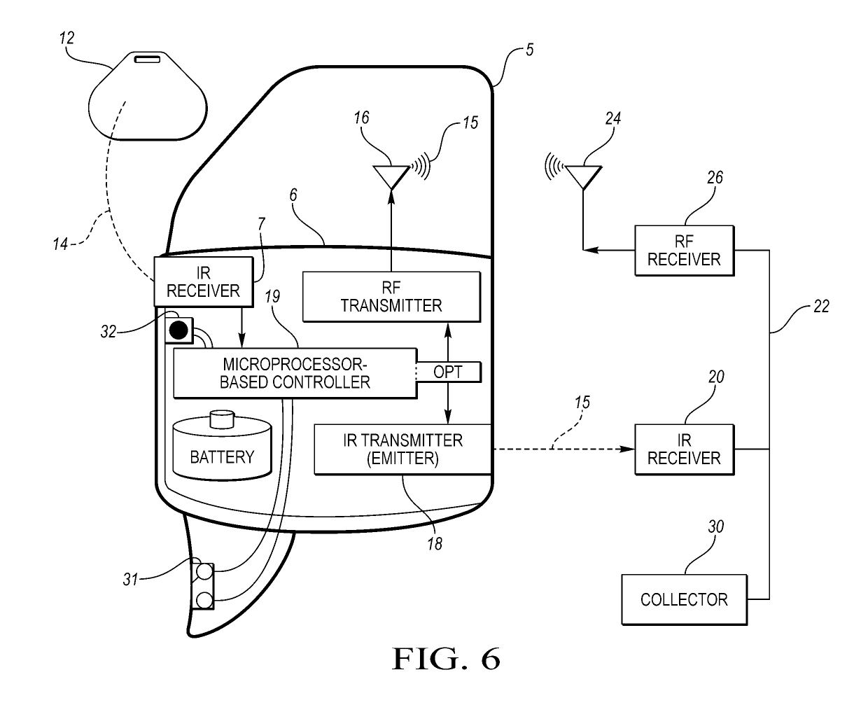

Referring now to the drawing figures, there is illustrated a real-time tracking system, generally indicated at 10, which may also be used to capture hand hygiene events as performed by subjects identified as caregivers and to determine compliant or non-compliant interactions of caregivers with subjects identified as patients. Referring specifically to FIGS. 3 and 6, the system 10 is comprised of tags 12 (worn by subjects or attached to objects) which emit infrared (i.e., IR) signals 14 which are captured by infrared receivers 20 common to the tracking system and a specialized transceiver 6 that upon activation of dispenser 5 reads an IR signal 14 from a caregiver badge, adds a data element which identifies the caregiver badge to its own identifying data element and transmits a qualified badge signal 15 which includes the two identifying data elements via an IR emitter 18 or RF transmitter 17. However, it is to be understood that the transducer 6 could transmit multiple signals to provide the necessary information.

Typically, the maximum effective line-of-sight range of such infrared signals 14 is about a twenty meter diameter 23 with the receiver of FIG. 4. To achieve higher granularity within the system 10, the infrared receiver 20 may have its field of view reduced to as little as a one meter diameter 27 by introducing a restrictor 25 in the IR sensor 20 (i.e., FIG. 5). The tags 12 may also transmit radio frequency (i.e., RF) signals 53 which are received by an RF receiver 26. The radio frequency signal 53 emitted by the antennas 16 are received by an antenna 24 of a radio frequency receiver 26 having a range of approximately forty meters 28 in all directions. Typically, information is collected using an in-ceiling and/or in-wall serial network 22 that terminates at the microprocessor-based collector 30.

The IR receiver 20 is stationary and its location is known. The dispenser 5 may or may not be stationary. Tags 12 are worn by mobile subjects and transmit unique IDs 14 which allow the tracking system 10 to associate unique subject identifiers (such as physician, nurse or patient) to each individual tag 12. With this association, when IR signals 14 are received by an IR receiver 20 or dispenser transceiver 6, the tracking system 10 identifies the tag(s) 12 (and hence the subject or subjects) relative to the location of the IR receiver. The tracking system 10 aggregates the unique IDs received from the tags 12 enabling the system 10 to identify when one or more unique IDs are present at a particular location (represented by an IR sensor 20). The tracking system 10 also calculates the amount of time that has passed since last receipt of each IR signal 14 at an IR sensor 20 or specialized transceiver 6.

Since it is important that certain tag-wearing subjects identified as givers of care (i.e., caregivers) to patients perform a hand cleansing event prior to interacting with other tag-wearing subjects identified as patients, the tracking system recognizes when a subject with a caregiver tag 18 activates the dispenser 5 to deliver hand cleaning agent. To accomplish this, an IR receiver 7 of the transceiver or tag 6 scans the area directly in front of the dispenser 5 when it is activated to detect an IR transmission 14 from the tag 12. The microprocessor-based controller 19 of the specialized transceiver 6 adds a data element which identifies the caregiver tag to its own identifying data element and transmits a modified badge signal 15 including the two identifying data elements via an IR emitter 18 or RF transmitter 17.

The specialized transceiver or badge 6 of each dispenser begins operating when it senses a state change in its trigger circuit. The state change may be indicated in a variety of ways as indicated in FIG. 6. The most straightforward activation method is to install a micro switch 31 into the dispenser 5 in such a way as to have the dispenser's activating paddle depress the switch to signal the state change when it is delivering cleaning agent. In another form, the specialized transceiver 6 may be activated by either an internal or external motion switch 32 that signals a state change upon sensing dispenser motion during the dispense event. Finally, when attached to an automated, powered dispenser the specialized transceiver 6 may receive the state change from the circuitry installed to govern the dispenser's operation.

In another embodiment, the transceivers or receivers may be part of a real-time locating system (RTLS) in which the transceivers or receivers cooperate with or include sensors that automatically identify and track the location of the personnel tags 12. In an RTLS system, the activation of the dispenser or entering/exiting a patient location area may be indicated due to the location of a particular personnel tag 12 being within a given proximity (e.g., three feet) of the transceiver or receiver. A compliance event can therefore be indicated by the location of the personnel in relation to the dispensers rather than a physical activation of the dispenser itself.

In any embodiment, the badge/tag can be mounted inside, outside, in or on the dispenser in any fashion that would allow accurate detection of activation of the dispenser. Upon activation of the dispenser, the transceiver in the badge/tag communicates with the collector via a wireless or wired network to store information indicating a “handwashing compliance” event.

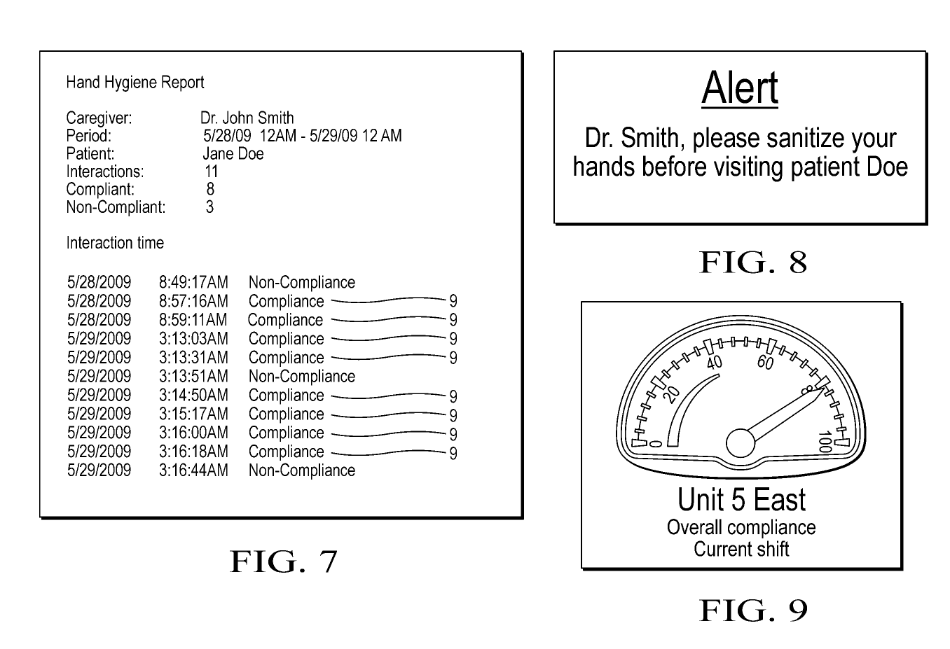

The tracking system 10 logs the status of the compliance event 9 (FIG. 7) associated with the modified badge signal 15 representative of the caregiver tag 33 as “compliant” and continues to monitor the unique ID received from the tag 12 for conditions that would relegate the caregiver tag 33 subject's status 9 from “compliant” to the default “non-compliant” state. Such conditions include (1) the passage of time, whereby after a predetermined interval, the status of the tag 12 (or the subject wearing the tag) is set to non-compliant or (2) the tag 12 is next detected by an IR receiver 20 in a zone wherein subjects are automatically designated “non-compliant”. Other conditions exist, as will be discussed.

The status of “compliant” or “non-compliant” may remain with the caregiver tag 33 until a condition causing a change in status is detected. For example, if a caregiver enters a patient room for only a brief moment, rather than merely delaying a warning indicating the absence of a hygiene-compliant status, the caregiver tag 33 will not change status to hygiene non-compliant until after a period of time elapses after entering the patient room.

With regard to caregiver and patient interactions, a caregiver subject 33 having completed a hand hygiene event will interact with the patient subject 34 as one would expect. When a caregiver subject 33 interacts with a patient subject 34 the IDs of caregiver and patient tags 12, the time, the location and the compliance status 9 is recorded in an appropriate database.

Actions are taken in near real time to alert non-compliant caregivers of their status and reward status compliant caregivers. These actions typically consist of audio and/or visual alerts on a portable device carried by the caregiver, a nearby computer workstation or other appliance capable of status 9 notification.

An example of possible alerts are shown in FIGS. 8 and 9. FIG. 8 illustrates a text alert that can be sent to devices such as an alphanumeric pager carried by the caregiver or a computer workstation in the immediate vicinity of the caregiver. FIG. 9 illustrates a dashboard type indicator that can be displayed at the central nurse's station for any given care unit.

The database is subsequently mined for management reporting, a representative sample of which can be seen in FIG. 7. This report is used to reward conscientious caregivers or to counsel/change the behavior of less conscientious caregivers. The data can be used to compare infection rates for various diseases to actual hand hygiene compliance rates and aid root-cause analysis/research.

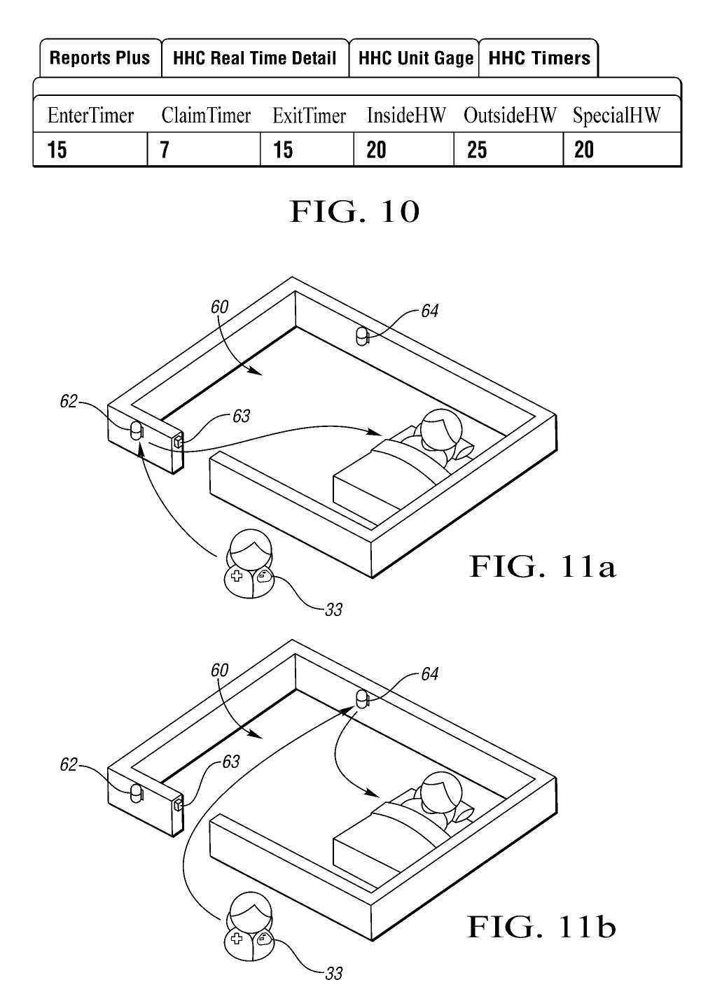

FIG. 10 illustrates a user interface according to one embodiment. The user interface may be displayed on a monitor or the like and visually and/or audibly communicates information regarding the system 10. The user interface displays a prompt allowing a user to set and control the timers associated with various tags on multiple dispensers or tags or transceivers located in or near the doors or passages that connect the patient location area with the common area. The timers can be individually set to any partial-second or partial-minute interval.

For example, the user is able to set the “Enter Timer” for dispensers within a patient care area, indicating a time value in which, after a handwashing event takes place within the patient care area, hygiene compliance remains with the caregiver. Upon the time value being exceeded, the tag associated with the caregiver is given a hygiene non-compliant status until another handwashing event occurs. The user is also able to set an “Exit Timer” for dispensers located outside of the patient care area. This time value may differ from the “Enter Timer” and indicates a time value in which, after a handwashing event takes place outside of the patient care area, hygiene compliance remains with the caregiver while outside of the patient care area.

A “Claim Timer” may be set that indicates the minimum amount of time that a caregiver must be either inside or outside of the patient care area to trigger any change to hygiene non-compliant. For example, the Claim Timer may be set to 7 seconds. If a caregiver is hygiene-compliant and enters a patient room for a time less than 7 seconds, the caregiver may not be assigned a status of non-compliant. However, if the caregiver remains in the patient room for a time exceeding the 7-second Claim Timer, (i) the caregiver may be assigned a status of non-compliant, or (ii) another timer may begin in which, upon exceeding that timer without accomplishing a handwashing event, the caregiver is assigned a status of non-compliant.

The user may also set “Inside HW” and “Outside HW” timers. These timers indicate the amount of time that the user will, regardless of other events, remain hygiene compliant after activation of a dispenser either when entering (Inside HW) or exiting (Outside HW) a patient care room. These timers correspond with an estimated time it takes for a caregiver to accomplish a full handwashing event. For example, when using an alcohol-based gel hand sanitizer, it may take a full 60 seconds to wipe hands entirely clean and dry, as opposed to 45 seconds when using soap and water. Following an activation of a dispenser and before the Inside/Outside HW timer has been exceeded, a caregiver can remain hygiene-compliant even while traveling from room to room.

Another timer may be provided in which the timer indicates the amount of time that the caregiver is allowed to remain assigned hygiene-compliant upon entering a patient care area, assuming the caregiver was already assigned hygiene-compliant when entering the patient care area. Similarly, another timer indicates the amount of time that the caregiver is allowed to remain assigned hygiene-compliant upon exiting the patient care area, assuming the caregiver was already assigned hygiene-compliant when exiting the patient care area.

A “Special HW” timer may be set indicating the amount of time that the caregiver is allowed to remain assigned hygiene-compliant when exiting or entering a patient care area if the assignment of hygiene-compliant was last given at a handwashing event in a “special location.” The special location may be, for example, a dispenser in the caregiver's office.

It should be understood that other timers can be individually calibrated or set or controlled such that the relationship between the activation of the dispensers is individually timed according to the caregiver facility's needs. For example, the user interface may also allow a user to set a timer for one type of dispenser (e.g., alcohol-based hand sanitizer) and a different time for a different type of dispenser (e.g., liquid soap dispenser). This may be useful if one type of dispenser (e.g., alcohol-based hand sanitizer) prolongs the cleanliness of a caregiver's hands when compared to another type of dispenser (e.g., liquid soap). Timers associated with a transceiver at or near the entrance/exit or the patient location area can also be similarly calibrated.

It should also be understood that the user can set each of the above-described timers individually and separately. A micro-managed approach to each dispenser throughout the facility is thus provided. The timers may begin when communication is made to the associated transceiver. A time limit for the timer may be commanded in the microprocessor within the badge/tag associated with its respective dispenser or entrance/exit. Alternatively, the timer may partially or entirely run by the computer and database (shown in FIG. 3) that is separate from the individual transceivers.

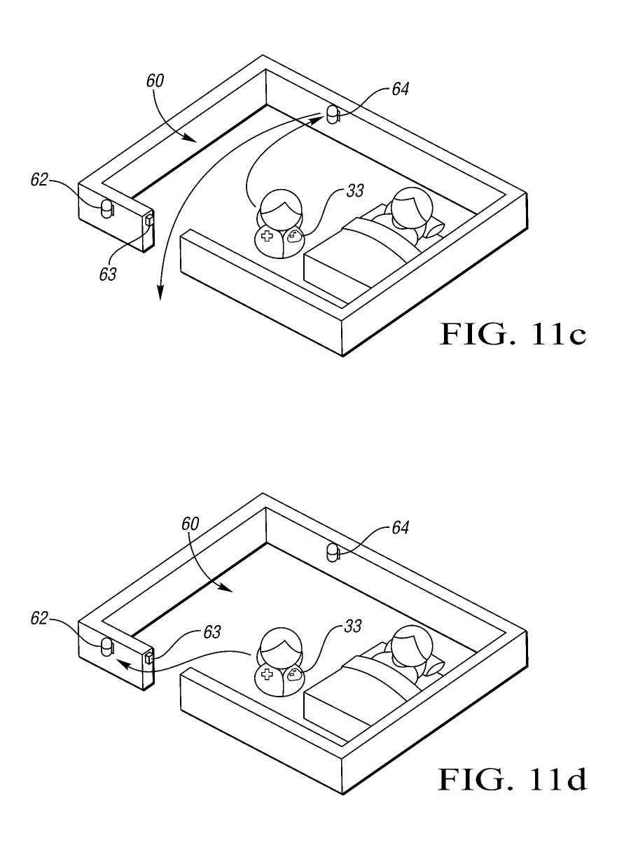

FIGS. 11(a)-(b) illustrate two scenarios in which a caregiver enters a patient location area such as a patient care room 60. In FIG. 11(a), the caregiver first activates a dispenser 62 located outside of the patient care room. The transceiver in or around the dispenser 62 senses the activation of the dispenser 62 and scans to receive a wireless signal send from the personnel badge 33 that includes corresponding ID information. Activation of the dispenser also activates a first timer (e.g., 45 seconds) in which the caregiver can enter the patient care room 60 and remain flagged as “hygiene-compliant” without having to activate another dispenser, such as dispenser 64 located within the patient care room. This timer may start for the caregiver when activating any dispenser at any location. For example, the caregiver may activate the dispenser 62 in the hallway outside of the patient care room 60. Upon activation of the dispenser 62, the first timer begins and is calibrated to time out or reach a time threshold after 45 seconds. Upon entering the patient care room 60 at any time before the timer times up, a transceiver 63 located on, above or near the doorway of the patient care room 60 detects the caregiver entering the patient care room 60 via interaction with the caregiver tag 33. The transceiver 63 may be located, for example, in the ceiling above the doorway into the patient room 60. The transceiver 63 should be disposed in a region in which detection of personnel entering or exiting a passageway between the patient location are 60 and a common area outside of the patient location area. Once the caregiver has entered the patient care room 60, the caregiver will not be flagged as “noncompliant.” Noncompliance will not be flagged at least until a secondary timer (indicating how long the caregiver is in the patient care room without a subsequent handwashing event) has elapsed. The secondary timer can be set to be a different time limit than the first timer. Alternatively, if the transceiver determines that the caregiver enters the patient care room 60 after the timer times up, the transceiver sends a signal to the database and the caregiver will be flagged as “hygiene-noncompliant” upon the transceiver 63 detecting the caregiver entering the patient care room 60.

FIG. 11(b) illustrates a situation in which the caregiver enters the patient care room 60, for example, after the time prescribed by the first timer (e.g., 45 seconds) has elapsed since the last handwashing event. Alternatively, the embodiment of FIG. 11(b) may be regardless of initial hygiene-compliant status prior to entering the patient location area 60. In this scenario, upon the transceiver 63 sensing entry into the patient care room, a second timer starts. This timer can have a different time limit (e.g., 15 seconds) than the first timer of the dispenser 62. The caregiver will be flagged as “hygiene-compliant” if the caregiver activates a dispenser 64 within the limits of the second timer after entering the patient care room 60. If the caregiver is in the care room for a time longer than the second timer without activating the dispenser 64, the caregiver will be flagged as “hygiene-noncompliant.”

In a system in which the timers of both FIGS. 11(a) and 11(b) are utilized, a caregiver will be flagged as “hygiene-noncompliant” if the caregiver enters the patient room 60 after the first timer times up (e.g., 45 seconds since the last hand washing event), and/or if the caregiver does not activate the dispenser 64 within the patient room prior to the second timer timing up (e.g., 15 seconds after entering the patient room). This provides additional accuracy to determine whether a caregiver is indeed hygiene compliant when interacting with patients.

FIGS. 11(c)-(d) illustrate two scenarios in which the caregiver exits the patient location area or patient care room 60. In FIG. 11(c), the caregiver first activates a dispenser 64 before leaving the patient care room 60. Once the dispenser 64 is activated, a first timer begins (e.g., 45 seconds) during which the caregiver may leave the patient room 60 and remain flagged as “hygiene-compliant.” After expiration of the first timer without leaving the patient care room 60, the caregiver may be flagged as “hygiene-noncompliant.” The status of hygiene-noncompliant may be assigned either based on the expiration of the timer, or based on the personnel exiting the patient location area 60 as determined by receiving the wireless signal from the personnel badge 33 via transceiver 63.

FIG. 11(d) illustrates a situation in which the caregiver exits the patient care room 60 without first activating the dispenser 64 within the room. Alternatively, the embodiment of FIG. 11(d) may be regardless of initial hygiene-compliant status prior to exiting the patient location area 60. Upon exiting the patient care room 60, a second timer starts that can have a different time limit (e.g., 15 seconds) than the first timer. Unless the caregiver activates a dispenser 62 (or another dispenser) outside of the patient care room 60 within the time prescribed by the second timer, the caregiver will be flagged as “hygiene-noncompliant.”

In a system in which the timers of both FIGS. 11(c) and 11(d) are utilized, a caregiver will be flagged as “hygiene-noncompliant” if the caregiver exits the patient room 60 after a time exceeding the first time (e.g., 45 seconds since the last hand washing event), and/or if the caregiver does not activate a dispenser within a second time after exiting the room (e.g., 15 seconds after exiting the patient room). This provides additional accuracy to determine whether a caregiver is indeed hygiene compliant when interacting with patients.

Systems incorporating the timers as illustrated in FIGS. 11(a)-(d) ensure proper hygiene compliance not only when entering a patient care room, but also when exiting the room. This ensures a handwashing event has taken place both before and after interaction with the patient to inhibit the patient from being exposed to the external environment as well as to inhibit the environment of the patient from being passed through the caregiving facility.

As explained above, it should also be understood that there may be a threshold timer that must be exceeded without handwashing or entering/exiting the room prior to the first and second timers being activated. This threshold timer may be a relative small amount of time (e.g., 5 seconds) and accounts for situations in which caregivers are merely walking by a patient room or merely opening the door to assess the situation within the room. If the caregiver is not by the patient care room for a time exceeding this threshold amount of time, the remaining timers are not activated and the caregiver will retain his/her compliance status.

In summary, at least one embodiment of the present invention provides a method for determining hand hygiene compliance status within a tracking environment. The method includes providing a real-time locating tag, which emits infrared (IR) and radio frequency (RF) signals that are received by ceiling-mounted sensors, for each subject whose hand hygiene status must be known. The data associated with each tag includes the subject's ID and a default hygiene compliance status of “non-compliant”. The provision of this tag in a tracking environment allows the real-time tracking system to associate unique tag data with a particular location. The method further includes adding a battery-powered IR receiver and IR or RF transmitting device (i.e., transceiver) to each hand cleaning agent dispenser that, upon activation, scans the IR receiver spectrum in front of the dispenser for a valid real-time locating caregiver tag for a short, preset interval. If the IR receiver device detects a value ID from a real-time locating tag, then the IR receiver adds an identifying data element to the ID detected and received from the locating tag and retransmits the modified ID to the tracking system through an IR or RF signal.

At least one embodiment of the present invention also provides a system for real-time compliance or non-compliance notification and recording of hygiene status at the time of patient care. The system includes the aforementioned real-time locating tag in a tracking environment which also provides for the continual monitoring of the data record associated with each subject's unique ID tag. All interaction events among subjects with tag IDs possessing a hand hygiene status of either “compliant” or “non-compliant” and subjects with tag IDs identifying the subject as a patient will be recorded within the tracking system. Appropriate, predetermined actions will be initiated based on the “compliant” or “non-compliant” status of the former subject in relation to his location, time and/or interaction with a tag-wearing subject identified as a patient. The tracking environment, or the area in which sensors are available to receive tag ID data, can be programmed to delineate certain areas as “non-patient care” or “patient care” areas.

Hand hygiene status of tag-wearing subjects will be “non-compliant” as the default state. The default state changes to “compliant” only when the tag ID is detected by the receiver of the transceiver attached to the cleaning agent dispenser. The hand hygiene “compliant” status may remain in effect until (1) sufficient time has passed according to a pre-set timeout, and/or (2) the subject enters a predetermined “non-patient care” area, and/or (3) the subject enters a “hygiene non-compliant” area and remains there for a period of time exceeding a threshold. Tag-wearing subjects in a “non-compliant” state attempting to provide care to another tag-wearing subject (identified as a patient in the tracking system) will receive an alert designed to allow the tag-wearing subject (caregiver) to perform corrective action, or a hand hygiene event, prior to continuing interaction with the patient. Further, a tag-wearing subject possessing a hand hygiene “compliant” status in patient care areas will receive an alert if the time interval between the hand hygiene compliance event and patient care event exceeds the predetermined value.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A real-time computer implemented method of monitoring hygiene compliance of personnel within a tracking environment provided by a real-time tracking apparatus, wherein auto-ID personnel tags are associated with personnel in the tracking environment, each personnel tag being capable of transmitting a wireless signal including ID information unique to its associated personnel tag, the tracking environment having a dispenser capable of dispensing a cleaning agent for hand washing, the method comprising:
assigning a status of hygiene-compliant to a person associated with one of the personnel tags based on a first transceiver associated with the dispenser (i) sensing activation of the dispenser indicating a handwashing event, and (ii) receiving a first wireless signal that includes the ID information transmitted by the personnel tag;
starting a timer in response to the activation of the dispenser; and
changing the status of hygiene-compliant to a status of hygiene-noncompliant based on (i) the timer timing out, and (ii) subsequently, a second wireless signal being received by a second transceiver associated with a passageway that communicates a patient location area with a common area, the second wireless signal including the ID information transmitted by the personnel tag indicating the personnel being in or around the passageway.

2. The method of claim 1, wherein the dispenser and first transceiver are located outside the patient location area, further comprising associating a third transceiver with a second dispenser located inside the patient location area.

3. The method of claim 2, further comprising starting a second timer in response to activation of the second dispenser, wherein the two timers are calibratible such that they are capable of timing out after different lengths of time.

4. The method of claim 1, wherein the dispenser and the first transceiver are located outside the patient location area, wherein the step of changing includes assigning a status of hygiene-noncompliant to the person associated with the detected personnel tag based on the personnel entering the patient location area through the passageway subsequent to the timer timing out.

5. The method of claim 1, wherein the dispenser and first transceiver are located inside of the patient location area, further comprising associating a third transceiver with a second dispenser located outside the patient location area.

6. The method of claim 5, further comprising starting a second timer in response to activation of the second dispenser, wherein the two timers are calibratible such that they are capable of timing out after different lengths of time.

7. The method of claim 5, wherein the dispenser and the first transceiver are located inside the patient location area, wherein the step of changing includes assigning a status of hygiene-noncompliant to the person associated with the detected personnel tag based on the personnel exiting the patient location area through the passageway subsequent to the timer timing out.

8. A real-time computer implemented method of monitoring hygiene compliance of personnel within a tracking environment provided by a real-time tracking apparatus, wherein auto-ID personnel tags are associated with personnel in the tracking environment, each personnel tag being capable of transmitting a wireless signal including ID information unique to its associated personnel tag, the tracking environment having a dispenser capable of dispensing a cleaning agent for hand washing, the method comprising:
starting a timer based on a first wireless signal being received by a first transceiver associated with a passageway that communicates a patient location area with a common area, the first wireless signal including the ID information transmitted by the personnel tag indicating the personnel being in or around the passageway; and
assigning a status of hygiene-noncompliant based on the timer timing out without a second transceiver associated with the dispenser (i) sensing activation of the dispenser and (ii) receiving a second wireless signal that includes the ID information transmitted by the personnel tag.

9. The method of claim 8, wherein the (i) sensing activation of the dispenser and the (ii) receiving a second wireless signal by the second transceiver indicates a handwashing event by the personnel associated with the personnel tag.

10. The method of claim 9, wherein the dispenser is inside the patient location area, wherein the step of starting includes starting the timer based on the first wireless signal being received by the first transceiver when the personnel enters the patient location area, and wherein the assigning includes assigning a status of hygiene-noncompliant based on the timer timing out after the personnel enters the patient location area prior to any subsequent handwashing event by the personnel.

11. The method of claim 9, wherein the dispenser is outside the patient location area, wherein the step of starting includes starting the timer based on the first wireless signal being received by the first transceiver when the personnel exits the patient location area, and wherein the assigning includes assigning a status of hygiene-noncompliant based on the timer timing out after the personnel exits the patient location area prior to any subsequent handwashing event by the personnel.

12. The method of claim 8, wherein the timer is calibratible.

13. The method of claim 8, further comprising assigning a status of hygiene-compliant based on the second transceiver (i) sensing activation of the dispenser and (ii) receiving the second wireless signal including the ID information transmitted by the personnel tag prior to the timer timing out.

14. The method of claim 13, further comprising starting a second timer in response to the activation of the dispenser, wherein the second timer is calibratible such that the second timer is enabled to differ in time from the timer.

15. The method of claim 8, wherein the second transceiver is mounted to an existing dispenser.

16. A real-time computer-implemented method of monitoring hygiene compliance of personnel within a tracking environment provided by real-time tracking apparatus, the tracking environment having first and second transceivers configured to scan an area to receive a wireless signal including ID information transmitted by a personnel tag detected within the area and associated with the personnel, the first transceiver associated with a dispenser capable of dispensing a cleaning agent for hand washing, the second transceiver associated with an entrance/exit of a patient location area to receive the ID information transmitted by a personnel tag indicating the personnel entering/exiting the patient location area, method comprising:
associating a first timer with the first transceiver that starts in response to activation of the dispenser;
associating a second timer with the second transceiver that starts in response to detection of personnel entering/exiting the patient location area;
assigning a status of hygiene-compliant to a person associated with one of the personnel tags based on the first transceiver (i) sensing activation of the dispenser indicating a handwashing event, and (ii) receiving a first wireless signal that includes the ID information transmitted by the personnel tag; and
changing the status of hygiene-compliant to a status of hygiene-noncompliant based on at least one of:
the personnel entering/exiting the patient location area subsequent to the first timer timing out since the previous handwashing event, and
the second timer timing out since the personnel entered/exited the patient location area without activating the dispenser.

17. The method of claim 16, wherein the first and second timers are different in time values.

18. The method of claim 16, wherein the first and second timers are calibratible.
